(19) United States
(12) Patent Application Publication
(10) Pub. No.: US 2025/0392853 A1
(43) Pub. Date: Dec. 25, 2025

(54) EARPHONES AND METHODS FOR CONTROLLING EARPHONES

(71) Applicant: SHENZHEN SHOKZ CO., LTD., Shenzhen (CN)

(72) Inventors: Jianhua XIE, Shenzhen (CN); Huan WANG, Shenzhen (CN)

(73) Assignee: SHENZHEN SHOKZ CO., LTD., Shenzhen (CN)

(21) Appl. No.: 19/307,120

(22) Filed: Aug. 22, 2025

Related U.S. Application Data
(63) Continuation of application No. PCT/CN2024/096475, filed on May 30, 2024.

(51) Int. Cl. H04R 1/10; H01Q 1/24

(52) U.S. Cl. CPC H04R 1/1066; H01Q 1/24; H04R 1/1008; H04R 1/1041; H04R 2420/07

(57) ABSTRACT

The present disclosure provides an earphone and a method for controlling an earphone. The earphone comprises a wearing component, a first loudspeaker component, a second loudspeaker component, a first antenna, a second antenna, and a control module. The wearing component connects the first loudspeaker component and the second loudspeaker component, and the first antenna is carried on the first loudspeaker component, and the second antenna is carried on the second loudspeaker component. The control module is configured to set one of the first antenna and the second antenna to a working state, and set the other to a standby state, and configured to switch the one of the first antenna and the second antenna to the standby state and switch the other to the working state in response to determining that a current antenna communication performance parameter of the earphone is smaller than or equal to a preset threshold.

### CROSS-REFERENCE TO RELATED APPLICATIONS

This application is a Continuation of International Patent Application No. PCT/CN2024/096475, filed on May 30, 2024, the entire contents of which are incorporated herein by reference.

### TECHNICAL FIELD

The present disclosure relates to the technical field of electronic devices, and in particular, an earphone and a method for controlling an earphone.

### BACKGROUND

In related technologies, integrated earphones typically include only a single antenna. Due to the inherent radiation characteristics of the single antenna, along with the absorption and reflection effects of the human head on the radiation of the antenna, there is always a certain angle at which the radiation is relatively weak, resulting in communication performance that fails to meet the required standards.

### SUMMARY

On the one hand, the present disclosure provides an earphone, comprising a wearing component, a first loudspeaker component, a second loudspeaker component, a first antenna, a second antenna, and a control module. The wearing component connects the first loudspeaker component and the second loudspeaker component so that in a wearing state, the first loudspeaker component and the second loudspeaker component are arranged on two sides of a head of a user, respectively. The first antenna is carried on the first loudspeaker component, and the second antenna is carried on the second loudspeaker component. The control module is configured to set one of the first antenna and the second antenna to a working state, and set the other of the first antenna and the second antenna to a standby state, and the control module is further configured to switch the one of the first antenna and the second antenna to the standby state and switch the other of the first antenna and the second antenna to the working state in response to determining that a current antenna communication performance parameter of the earphone is smaller than or equal to a preset threshold.

In some embodiments, the earphone further comprises a radio frequency chip and a switching element. The control module is configured to control the switching element to connect the one of the first antenna and the second antenna to a radio frequency port of the radio frequency chip so that the one of the first antenna and the second antenna is in the working state, and the control module is further configured to control the switching element to disconnect the other of the first antenna and the second antenna from the radio frequency port of the radio frequency chip so that the other of the first antenna and the second antenna is in the standby state.

In some embodiments, the radio frequency chip and the switching element are carried on the first loudspeaker component, the second antenna is configured to be connected to the switching element via a radio frequency trace carried on the wearing component, and the control module is configured to set the first antenna to the working state in response to a power-on instruction of the earphone.

In some embodiments, the earphone further comprises a circuit board component and a battery. The control module, the radio frequency chip, and the switching element are arranged on the circuit board component, the first antenna and the circuit board component are arranged in a housing of the first loudspeaker component, the second antenna and the battery are arranged in a housing of the second loudspeaker component, and a clearance of the first antenna is greater than a clearance of the second antenna.

In some embodiments, the control module is configured to set the first antenna to the working state in response to a power-on instruction of the earphone.

In some embodiments, the second antenna is configured to be connected to the switching element via a radio frequency trace carried on the wearing component. The first antenna is provided with a first feed point and a grounding point, and the second antenna is only provided with a second feed point connected to the radio frequency trace.

In some embodiments, the first antenna is a Planar Inverted-F Antenna (PIFA), and the second antenna is a monopole antenna.

In some embodiments, the earphone further comprises a boom microphone component. The boom microphone component includes a boom arm, a microphone, and a pivot mechanism, the microphone and the pivot mechanism are arranged at two ends of the boom arm, respectively, the pivot mechanism is rotatably connected to the housing of the first loudspeaker component, and the first antenna is arranged around a periphery of the pivot mechanism in a semi-closed manner.

In some embodiments, in at least one horizontal plane gain radiation pattern equidistant from the first antenna and the second antenna, within a first angle range, a radiation gain of the first antenna is better than a radiation gain of the second antenna, and within a second angle range, the radiation gain of the second antenna is better than the radiation gain of the first antenna, the first angle range is larger than the second angle range. The control module is configured to set the first antenna to the working state in response to a power-on instruction of the earphone.

In some embodiments, the control module is configured to detect a signal strength received by the one of the first antenna and the second antenna in the working state, and generate the current antenna communication performance parameter in real-time; or the control module is configured to receive the current antenna communication performance parameter or a switching instruction generated based on the current antenna communication performance parameter from a paired device. The paired device is connected to the earphone through the one of the first antenna and the second antenna in the working state, and is configured to generate the current antenna communication performance parameter in real-time based on the signal strength.

On the other hand, the present disclosure provides a method for controlling an earphone. The earphone includes a wearing component, a first loudspeaker component, a second loudspeaker component, a first antenna, and a second antenna. The wearing component connects the first loudspeaker component and the second loudspeaker component so that in a wearing state, the first loudspeaker component and the second loudspeaker component are arranged on two sides of a head of a user, respectively, the first antenna is carried on the first loudspeaker component, and the second antenna is carried on the second loudspeaker component. The method comprises: setting one of the first antenna and the second antenna to a working state, and setting the other of the first antenna and the second antenna to a standby state; determining whether a current antenna communication performance parameter of the earphone is smaller than or equal to a preset threshold; and switching the one of the first antenna and the second antenna to the standby state and switching the other of the first antenna and the second antenna to the working state in response to determining that the current antenna communication performance parameter of the earphone is smaller than or equal to the preset threshold.

In some embodiments, the determining whether a current antenna communication performance parameter of the earphone is smaller than or equal to a preset threshold includes: detecting a signal strength received by the one of the first antenna and the second antenna in the working state, and generating the current antenna communication performance parameter in real-time, and determining whether the current antenna communication performance parameter is smaller than or equal to the preset threshold; or receiving the current antenna communication performance parameter or a switching instruction generated based on the current antenna communication performance parameter from a paired device. The paired device is connected to the earphone through the one of the first antenna and the second antenna in the working state, and generating the current antenna communication performance parameter in real-time based on the signal strength.

In the scheme of the present disclosure, the earphone comprises the first antenna and the second antenna, the first antenna is carried on the first loudspeaker component, and the second antenna is carried on the second loudspeaker component, and the control module has the function to switch an antenna to the working state. The control module is configured to set the one of the first antenna and the second antenna to the working state, and set the other of the first antenna and the second antenna to the standby state, and detect in real-time whether the current antenna communication performance parameter of the earphone is smaller than or equal to the preset threshold. In response to determining that the current antenna communication performance parameter of the earphone is less than or equal to the preset threshold, it indicates that the radiation of the antenna in the working state within the current angle range is weak and cannot meet the communication requirements. At this time, the control module sets the one of the first antenna and the second antenna to the standby state, and switches the other of the first antenna and the second antenna to the working state. By switching the working antenna, the communication performance of the earphone within the current angle range is improved, thereby meeting the communication requirements.

### BRIEF DESCRIPTION OF THE DRAWINGS

In order to more clearly illustrate the technical solutions in the embodiments of the present disclosure, the drawings required for use in the description of the embodiments are briefly introduced below. Obviously, the drawings described below are only some embodiments of the present disclosure. For those of ordinary skill in the art, other drawings can be obtained based on these drawings without creative work, where:

FIG. 1 is a schematic diagram illustrating an exemplary structure of an earphone according to one embodiment of the present disclosure;

FIG. 2 is a schematic diagram illustrating a principle of a control module switching a working antenna;

FIG. 3 is a schematic diagram illustrating an exemplary structure of a first loudspeaker component in FIG. 1;

FIG. 4 is a schematic diagram illustrating an exemplary structure of a second loudspeaker component in FIG. 1;

FIG. 5 is a schematic diagram illustrating an exemplary structure of a first antenna in FIG. 3;

FIG. 6 is a schematic diagram illustrating an exemplary structure of a second antenna in FIG. 4;

FIG. 7 is a diagram illustrating a horizontal plane gain radiation pattern of a first antenna and a second antenna; and

FIG. 8 is a flowchart illustrating a method for controlling an earphone according to embodiments of the present disclosure.

### DETAILED DESCRIPTION

The technical solutions in the embodiments of the present disclosure will be clearly and completely described below in conjunction with the drawings in the embodiments of the present disclosure. It will be understood that the specific embodiments described herein are only used to explain the present disclosure, rather than to limit the present disclosure. It should also be noted that, for ease of description, only some but not all structures related to the present application are shown in the drawings. Based on the embodiments in the present disclosure, all other embodiments obtained by ordinary technicians in the field without making creative work are within the scope of protection of the present disclosure.

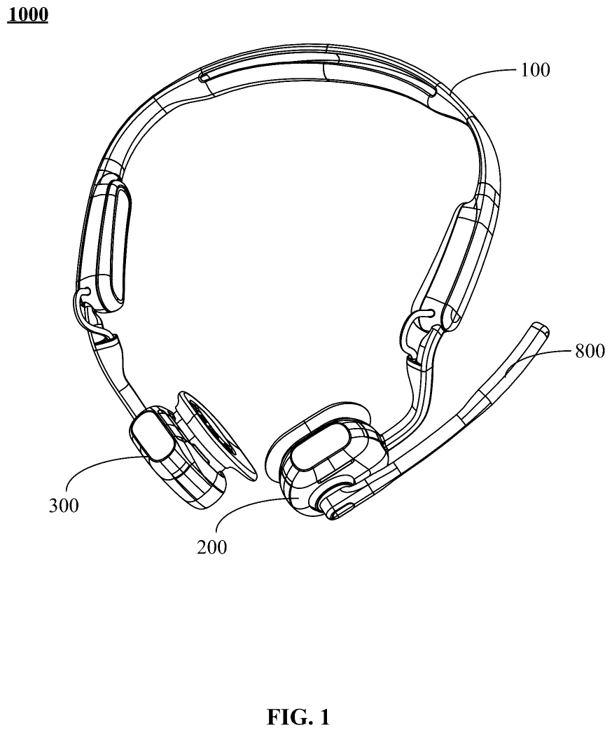

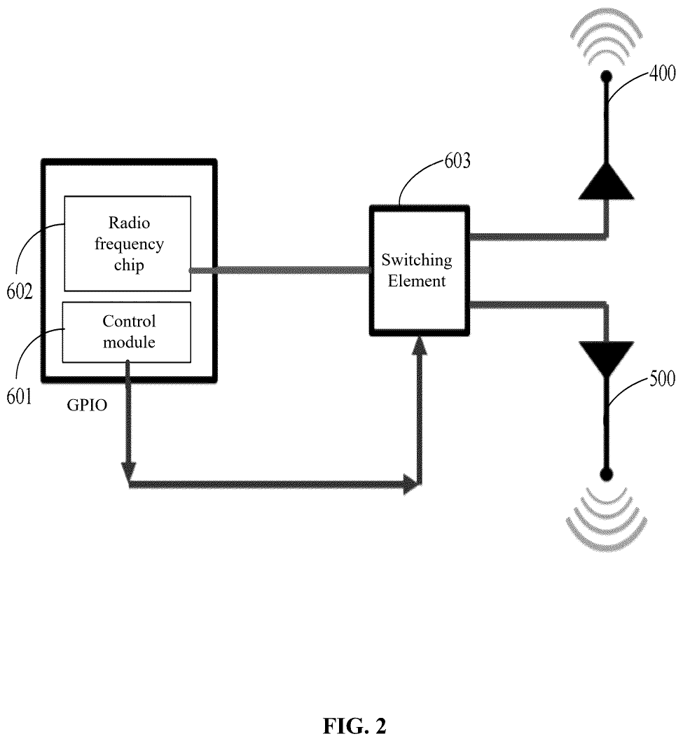

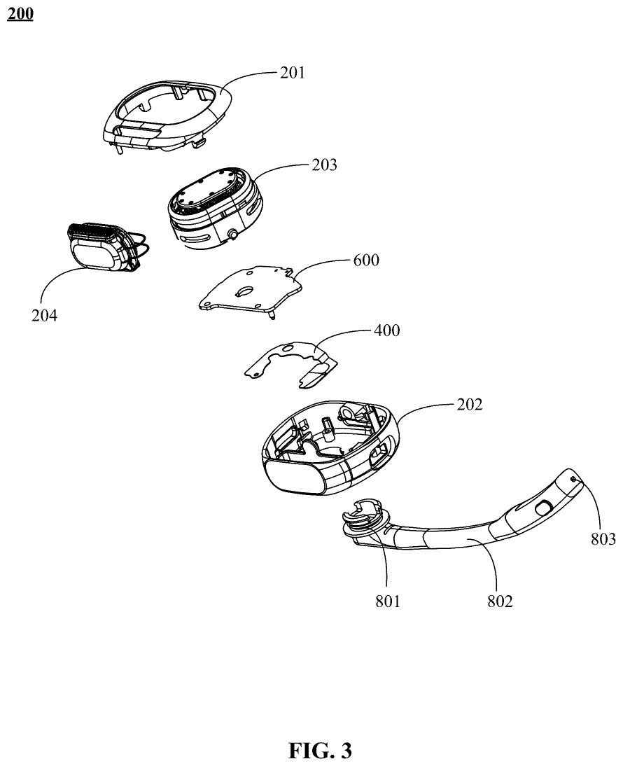

As shown in FIG. 1 to FIG. 4, FIG. 1 is a schematic diagram illustrating an exemplary structure of an earphone 1000 according to one embodiment of the present disclosure. FIG. 2 is a schematic diagram illustrating a principle of a control module 601 switching a working antenna. FIG. 3 is a schematic diagram illustrating an exemplary structure of a first loudspeaker component 200 in FIG. 1. FIG. 4 is a schematic diagram illustrating an exemplary structure of a second loudspeaker component 300 in FIG. 1. In this embodiment, the earphone 1000 comprises a wearing component 100, the first loudspeaker component 200, the second loudspeaker component 300, a first antenna 400, a second antenna 500, and the control module 601. The wearing component 100 connects the first loudspeaker component 200 and the second loudspeaker component 300, so that in a wearing state, the first loudspeaker component 200 and the second loudspeaker component 300 are arranged on two sides of a user's head, respectively. The first antenna 400 is carried on the first loudspeaker component 200, and the second antenna 500 is carried on the second loudspeaker component 300, the control module 601 is configured to set one of the first antenna 400 and the second antenna 500 to a working state, and set the other of the first antenna 400 and the second antenna 500 to a standby state. In response to determining that a current antenna communication performance parameter of the earphone 1000 is less than or equal to a preset threshold, the control module 601 is further configured to switch the one of the first antenna 400 and the second antenna 500 to the standby state and switch the other of the first antenna 400 and the second antenna 500 to the working state.

In the scheme of this embodiment, the earphone 1000 comprises the first antenna 400 and the second antenna 500, the first antenna 400 is carried on the first loudspeaker component 200, and the second antenna 500 is carried on the second loudspeaker component 300. The control module 601 has the function to switch an antenna to the working state. The control module 601 is configured to set one of the first antenna 400 and the second antenna 500 to the working state, set the other of the first antenna 400 and the second antenna 500 to the standby state, and detect in real-time whether the current antenna communication performance parameter of the earphone is smaller than or equal to the preset threshold. In response to determining that the current antenna communication performance parameter of the earphone 1000 is less than or equal to the preset threshold, the control module 601 is further configured to switch the one of the first antenna 400 and the second antenna 500 to the standby state and switch the other of the first antenna 400 and the second antenna 500 to the working state. When the current antenna communication performance parameter of the earphone 1000 is less than or equal to the preset threshold, it indicates that the radiation of the antenna in the working state within the current angle range is weak and cannot meet the communication requirements. At this time, the control module 601 sets the one of the first antenna 400 and the second antenna 500 to the standby state, and switches the other of the first antenna 400 and the second antenna 500 to the working state. By switching the working antenna, the communication performance of the earphone 1000 within the current angle range is improved, thereby meeting the communication needs.

When the current antenna communication performance parameter of the earphone 1000 is greater than the preset threshold, it indicates that a radiation intensity of the antenna in working state within the current angle range can meet the communication requirements. At this time, there is no need to switch the working antenna, so that the antenna in the working state is always maintained in a high-performance state.

The present disclosure does not limit the specific values of the preset threshold, and those skilled in the art can make a choice based on actual needs. If the preset threshold is too small, the working antenna may not be switched in time, the antenna in working state will be more susceptible to external interference when the signal strength is weak, thus failing to meet the communication requirements. If the preset threshold is too large, it may lead to overly frequent switching. For example, the current antenna communication performance parameter of the current antenna of the earphone 1000 when the communication between the earphone 1000 and a paired device starts to lag may be selected as the preset threshold. For example, the current antenna communication performance parameter may be a received signal strength indicator (RSSI), a received channel power indicator (RCPI), or the like. The present disclosure does not limit this, and those skilled in the art can make a choice based on actual needs.

As shown in FIG. 2, in some embodiments, the earphone 1000 may further comprise a radio frequency (RF) chip 602 and a switching element 603. The control module 601 is configured to switch the switching element 603 to connect the one of the first antenna 400 and the second antenna 500 to a RF port of the RF chip 602 so that the one of the first antenna 400 and the second antenna 500 is in the working state. The control module 601 is further configured to switch the switching element 603 to disconnect the other of the first antenna 400 and the second antenna 500 from the RF port of the RF chip 602 so that the other of the first antenna 400 and the second antenna 500 is in the standby state.

Specifically, the switching element 603 is connected to the RF port of the RF chip 602 via an RF circuit, and is switchably connected to one of the first antenna 400 and the second antenna 500 via the RF circuit. For example, when the switching element 603 is connected to the first antenna 400 via the RF circuit, the switching element 603 and the second antenna 500 may be in a disconnected state, at this time, the first antenna 400 is in the working state and the second antenna 500 is in the standby state; when the switching element 603 is connected to the second antenna 500 via the RF circuit, the switching element 603 and the first antenna 400 may be in a disconnected state, at this time, the second antenna 500 is in the working state and the first antenna 400 is in the standby state.

The switching element 603 is connected to the control module 601 via a control circuit, so that the control module 601 can control the switching element 603 to be switchably connected to one of the first antenna 400 and the second antenna 500. As shown in FIG. 2, in some embodiments, the control module 601 and the RF chip 602 may be integrated on the same main chip. In some embodiments, the control module 601 and the RF chip 602 may be two independent chips, which is not limited in the present disclosure, and those skilled in the art may make selections based on actual needs.

A switching between the first antenna 400 and the second antenna 500 is achieved by the switching element 603, with fast switching speed and high control accuracy. In some embodiments, the switching between the first antenna 400 and the second antenna 500 may also be achieved only by software, which is not limited in the present disclosure, and those skilled in the art may make selections based on actual needs.

In some embodiments, the RF chip 602 and the switching element 603 are carried on the first loudspeaker component 200, the second antenna 500 is configured to be connected to the switching element 603 via an RF trace carried on the wearing component 100, and the control module 601 is configured to set the first antenna 400 to the working state in response to a power-on instruction of the earphone 1000.

Specifically, the first antenna 400, the RF chip 602, and the switching element 603 may all be carried on the first loudspeaker component 200, so a connection distance between the first antenna 400 and the switching element 603 is short and the energy loss is small. The second antenna 500 is carried on the second loudspeaker component 300, and the second antenna 500 may be connected to the switching element 603 via the RF trace carried on the wearing component 100. At this time, a connection distance between the second antenna 500 and the switching element 603 is long and the energy loss is large, so that performance of the first antenna 400 is better than the performance of the second antenna 500. At this time, the first antenna 400 with better performance may be used as a main antenna, and the second antenna 500 may be used as an auxiliary antenna. The control module 601 may set the first antenna 400, i.e., the main antenna, to the working state in response to the power-on instruction of the earphone 1000, so that the earphone 1000 has relatively good communication performance after powering on. By setting the first antenna 400 and the second antenna 500 to have different performances, with the one with better performance being as the main antenna and the other being as the auxiliary antenna, it is beneficial to reduce the frequency of switching and reducing the power consumption of the earphone 1000.

For example, a length of the RF trace may be in a range of 400 mm to 600 mm, and the energy loss is in a range of 2 dB to 4 dB, which is not limited in the present disclosure, and those skilled in the art may make selections based on actual needs.

As shown in FIG. 3 and FIG. 4, in some embodiments, the earphone 1000 further comprises a circuit board component 600 and a battery 700. The control module 601, the RF chip 602, and the switching element 603 are arranged on the circuit board component 600, the first antenna 400 and the circuit board component 600 are arranged in a housing of the first loudspeaker component 200, and the second antenna 500 and the battery 700 are arranged in a housing of the second loudspeaker component 300. A clearance of the first antenna 400 is greater than a clearance of the second antenna 500. Further, the control module 601 may set the first antenna 400 to the working state in response to the power-on instruction of the earphone 1000.

As shown in FIG. 3, the first loudspeaker component 200 may include a first housing component, a first bone-conducting loudspeaker 203 supported by the first housing component, and a first air-conducting loudspeaker 204 supported by the first housing component. The first housing component may include a first upper housing 201 and a first lower housing 202. In the wearing state, the first upper housing 201 is closer to the head than the first lower housing 202. The first upper housing 201 and the first lower housing 202 may enclose to form a first accommodation space, and the first accommodation space is configured to accommodate the circuit board component 600 and the first antenna 400. The circuit board component 600 may be arranged on a side of the first bone-conducting loudspeaker 203 close to the first lower housing 202, and the first antenna 400 may be arranged between the circuit board component 600 and the first lower housing 202, and attached to an inner side surface of the first lower housing 202.

For example, the first antenna 400 may be made of flexible printed circuit (FPC) material, which is not limited in the present disclosure, and those skilled in the art may make selections based on actual needs.

As shown in FIG. 4, the second loudspeaker component 300 may include a second housing component, a second bone-conducting loudspeaker 303 supported by the second housing component, and a second air-conducting loudspeaker 304 supported by the second housing component. The second housing component may include a second upper housing 301 and a second lower housing 302. In the wearing state, the second upper housing 301 is closer to the head than the second lower housing 302. The second upper housing 301 and the second lower housing 302 may enclose to form a second accommodation space, and the second accommodation space is configured to accommodate the battery 700 and the second antenna 500. The battery 700 may be arranged on a side of the second bone-conducting loudspeaker 303 close to the second lower housing 302, and the second antenna 500 may be arranged between the circuit board component 600 and the second lower housing 302, and attached to an inner side surface of the second lower housing 302.

Since the battery 700 occupies a larger space than the circuit board component 600, the first antenna 400 has a larger clearance than the second antenna 500, thereby making the performance of the first antenna 400 better than the performance of the second antenna 500. At this time, the first antenna 400 with better performance may be used as the main antenna, and the second antenna 500 may be used as the auxiliary antenna. The control module 601 may set the first antenna 400, i.e., the main antenna, to the working state in response to the power-on instruction of the earphone 1000, so that the earphone 1000 has relatively good communication performance after powering on. By setting the first antenna 400 and the second antenna 500 to have different performances, with the one with better performance being as the main antenna and the other being as the auxiliary antenna, it is conducive to reducing the frequency of switching and reducing the power consumption of the earphone 1000.

In some embodiments, the first loudspeaker component 200 or the second loudspeaker component 300 may also include only a bone-conducting loudspeaker or only an air-conducting loudspeaker, which is not limited in the present disclosure, and those skilled in the art may make selections based on actual needs.

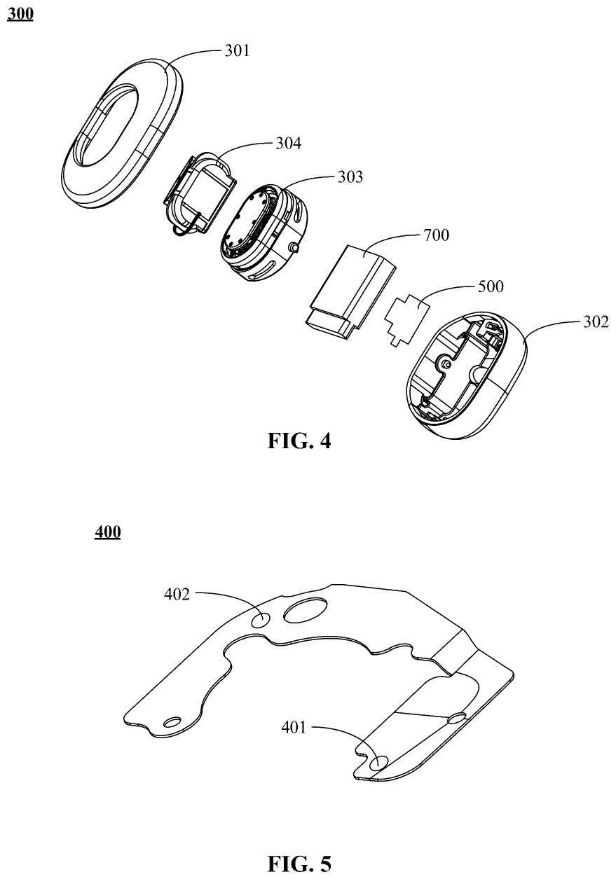

As shown in FIG. 5, FIG. 5 is a schematic diagram illustrating an exemplary structure of the first antenna 400 in FIG. 3. In some embodiments, the first antenna 400 is provided with a first feed point 401 and a grounding point 402, the first feed point 401 may be connected to the switching element 603 on the circuit board component 600 through a spring pin, and the grounding point 402 may be connected to a common terminal on the circuit board component 600 through a spring pin.

As shown in FIG. 6, FIG. 6 is a schematic diagram illustrating an exemplary structure of the second antenna 500 in FIG. 4. In some embodiments, the second antenna 500 is connected to the switching element 603 on the circuit board component 600 via the RF trace carried on the wearing component 100. The second antenna 500 may be provided with only a second feed point 501, and the second feed point 501 is connected to the switching element 603 on the circuit board component 600 via the RF trace to reduce the wiring difficulty of the RF trace.

For example, the first antenna 400 may be Planar Inverted-F Antenna (PIFA), and the second antenna 500 may be a monopole antenna. In some embodiments, the first antenna 400 and the second antenna 500 may also be antennas of the same type. The present disclosure does not limit the specific types of the first antenna 400 and the second antenna 500, and those skilled in the art may make selections based on actual needs.

As shown in FIG. 1 and FIG. 3, in some embodiments, the earphone 1000 may further comprise a boom microphone component 800. The boom microphone component 800 includes a pivot mechanism 801, a boom arm 802, and a microphone 803. The microphone 803 and the pivot mechanism 801 are arranged at two ends of the boom arm 802, respectively, and the pivot mechanism 801 is rotatably connected to the first lower housing 202 of the first loudspeaker component 200. The first antenna 400 is arranged around a periphery of the pivot mechanism 801 in a semi-closed manner.

As shown in FIG. 3 and FIG. 5, a shape of the first antenna 400 may be adapted to match a contour of the first lower housing 202, and is integrally arranged in a “C” shape. In other words, the first antenna 400 may be an open semi-circular structure, and is arranged around the pivot mechanism 801, and spatially avoids the pivot mechanism 801, which is conducive to improving space utilization. By configuring the first antenna 400 as the open semi-circular structure, it can be adapted to a wide variety of complex housing designs, thereby enhancing the versatility of the first antenna 400.

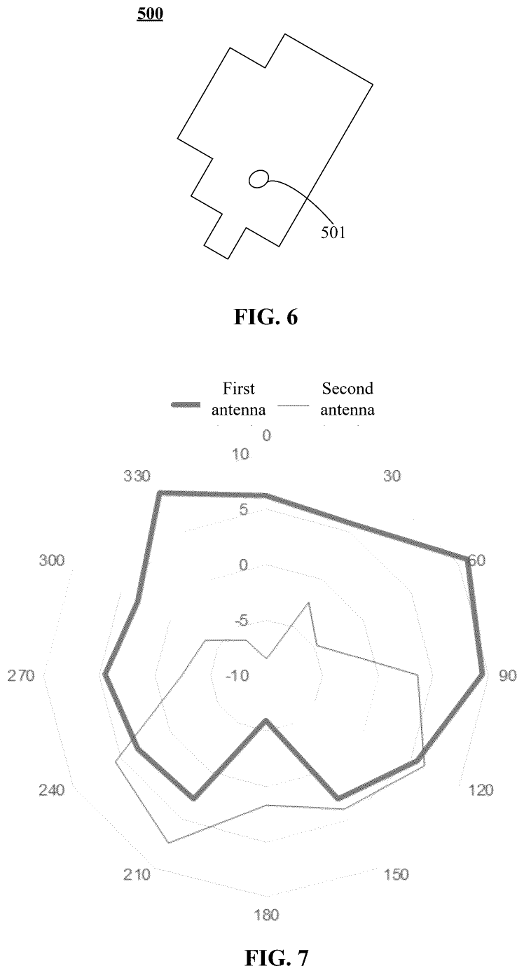

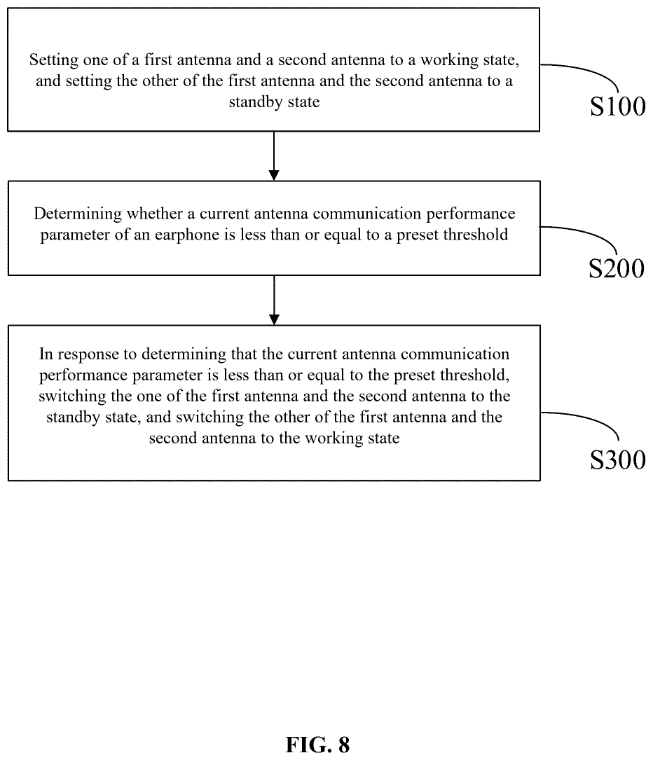

As shown in FIG. 7, FIG. 7 is a diagram illustrating a horizontal plane gain radiation pattern of the first antenna 400 and the second antenna 500. In some embodiments, in at least one horizontal plane gain radiation pattern equidistant from the first antenna 400 and the second antenna 500, within a first angle range, a radiation gain of the first antenna 400 is better than a radiation gain of the second antenna 500, within a second angle range, a radiation gain of the second antenna 500 is better than a radiation gain of the first antenna 400, the first angle range is larger than the second angle range. The control module 601 is configured to set the first antenna 400 to the working state in response to the power-on instruction of the earphone 1000.

The first angle range is greater than the second angle range, indicating that the omnidirectionality of the first antenna 400 is overall superior to that of the second antenna 500. At this time, the first antenna 400 with better omnidirectionality may be used as the main antenna, and the second antenna 500 may be used as the auxiliary antenna. The control module 601 may set the first antenna 400, i.e., the main antenna, to the working state in response to the power-on instruction of the earphone 1000, so that the earphone 1000 has relatively good communication performance after powering on. By setting the first antenna 400 and the second antenna 500 to have different directivities, with the one with better omnidirectionality being as the main antenna, and the other being as the auxiliary antenna, it is conducive to reducing the frequency of switching and reducing the power consumption of the earphone 1000.

In some embodiments, the sum of the first angle range and the second angle range may be 360 degrees, so that one of the first antenna 400 and the second antenna 500 may be adaptively switched to be in the working state to achieve full 360-degree omnidirectional radiation.

For example, when the paired device, such as a mobile phone, that communicates with the earphone 1000 is in a relative position relative to a wearer/the earphone so that an antenna gain direction is within the first angle range, the control module 601 may set the first antenna 400 to be in the working state and the second antenna 500 to be in the standby state. When the movement of the earphone 1000 or the paired device causes the antenna gain direction to be within the second angle range, the working performance of the first antenna 400 may deteriorate. In response to detecting that the current antenna communication performance parameter of the earphone 1000 is less than or equal to the preset threshold, the control module 601 may set the second antenna 500 to be in the working state and the first antenna 400 to be in the standby state; in response to detecting that the current antenna communication performance parameter of the earphone 1000 is greater than the preset threshold, the control module 601 may maintain the first antenna 400 in the working state and the second antenna 500 in the standby state, so that the working antenna is always maintained in a high-performance state.

In some embodiments, the control module 601 is configured to detect the signal strength received by the one of the first antenna 400 and the second antenna 500 in the working state, and generate the current antenna communication performance parameter in real-time.

For example, when the earphone 1000 and the mobile phone are communicating, the first antenna 400, i.e., the main antenna, is in the working state, and the second antenna 500, i.e., the auxiliary antenna, is in the standby state, the control module 601 may detect a signal strength received by the first antenna 400 from the mobile phone and generate the current antenna communication performance parameter in real-time. In response to detecting that the current antenna communication performance parameter is less than or equal to the preset threshold, i.e., when the communication requirements cannot be met, the control module 601 is configured to set the second antenna 500 to the working state and the first antenna 400 to the standby state. By utilizing the control module 601 to detect the current antenna communication performance parameter and perform the threshold determination on the earphone 1000 side, it facilitates rapid switching of the working antenna when the communication performance of the current working antenna of the earphone 1000 is poor.

In some embodiments, the control module 601 is configured to receive the current antenna communication performance parameter or a switching instruction generated based on the current antenna communication performance parameter from the paired device. The paired device is communicated with the earphone 1000 through the one of the first antenna 400 and the second antenna 500 in the working state, and generates the current antenna communication performance parameter in real-time based on the signal strength.

For example, the paired device is a mobile phone, the earphone 1000 and the mobile phone are communicating, the first antenna 400, i.e., the main antenna, is in the working state, and the second antenna 500, i.e., the auxiliary antenna, is in the standby state. The mobile phone may detect a signal strength received from the earphone 1000, and generate the current antenna communication performance parameter in real-time, and then send the current antenna communication performance parameter to the control module 601, so that the control module 601 can determine whether the current antenna communication performance parameter is less than or equal to the preset threshold. In some embodiments, the mobile phone detects the signal strength received from the earphone 1000, and generates the current antenna communication performance parameter in real-time, and further determines whether the current antenna communication performance parameter is less than or equal to the preset threshold. In this case, the mobile phone may generate the switching instruction when the current antenna communication performance parameter is less than or equal to the preset threshold, and send the switching instruction to the control module 601. Upon receiving the switching instruction, the control module 601 is configured to set the second antenna 500 to the working state and the first antenna 400 to the standby state.

As shown in FIG. 8, FIG. 8 is a flowchart illustrating a process of a method for controlling the earphone 1000 according to embodiments of the present disclosure. As shown in FIG. 1 to FIG. 4, the earphone 1000 comprises the wearing component 100, the first loudspeaker component 200, the second loudspeaker component 300, the first antenna 400, and the second antenna 500. The wearing component 100 connects the first loudspeaker component 200 and the second loudspeaker component 300, so that in a wearing state, the first loudspeaker component 200 and the second loudspeaker component 300 are arranged on two sides of a user's head, respectively. The first antenna 400 is carried on the first loudspeaker component 200, and the second antenna 500 is carried on the second loudspeaker component 300. A further detailed description of the earphone 1000 may be consistent with the earphone 1000 described above, and will not be repeated here.

The method comprises the following operations.

Step 100, one of the first antenna 400 and the second antenna 500 is set to a working state, and the other of the first antenna 400 and the second antenna 500 is set to a standby state.

A detailed description of step 100 may be consistent with the earphone 1000 described above, and will not be repeated here.

Step 200, whether a current antenna communication performance parameter of the earphone 1000 is less than or equal to a preset threshold is determined.

In some embodiments, Step 200 may be implemented by the following steps.

Step 201, a signal strength received by the one of the first antenna 400 and the second antenna 500 in the working state is detected, and the current antenna communication performance parameter is generated in real-time, and whether the current antenna communication performance parameter is less than or equal to a preset threshold is determined.

A detailed description of step 201 may be consistent with the earphone 1000 described above, and will not be repeated here.

In some embodiments, Step 200 may be implemented by the following steps.

Step 202, the current antenna communication performance parameter or a switching instruction generated based on the current antenna communication performance parameter is received from a paired device, the paired device being connected to the earphone 1000 through the one of the first antenna 400 and the second antenna 500 in the working state, and the current antenna communication performance parameter is generated in real-time based on the signal strength.

A detailed description of step 202 may be consistent with the earphone 1000 described above, and will not be repeated here.

Step 300, in response to determining that the current antenna communication performance parameter is less than or equal to the preset threshold, the one of the first antenna 400 and the second antenna 500 is switched to the standby state, and the other of the first antenna 400 and the second antenna 500 is switched to the working state.

A detailed description of step 300 may be consistent with the earphone 1000 described above, and will not be repeated here.

In the above description of the present disclosure, unless otherwise clearly specified and limited, the terms “fix”, “install”, “connection” or “connect” should be understood in a broad sense. For example, with regard to the term “connection”, it can be a fixed connection, a detachable connection, or an integral one; it can be a mechanical connection or an electrical connection; it can be a direct connection or an indirect connection through an intermediate medium, or it can be the internal connection of two elements or the interaction relationship between two elements. Therefore, unless otherwise clearly defined in the present disclosure, those skilled in the art can understand the specific meanings of the above terms in the present disclosure according to the specific circumstances.

According to the above description of the present disclosure, those skilled in the art may also understand that the terms used below, such as “up”, “down”, “front”, “back”, “left”, “right”, “length”, “width”, “thickness”, “vertical”, “horizontal”, “top”, “bottom”, “inside”, “outside”, “axial”, “radial”, “circumferential”, “center”, “longitudinal”, “lateral”, “clockwise” or “counterclockwise”, etc., which indicate the orientation or position relationship, are based on the orientation or position relationship shown in the drawings of the present disclosure, and are only for the purpose of facilitating the explanation of the scheme of the present invention and simplifying the description, rather than explicitly or implicitly indicating that the device or element involved must have the specific orientation, be constructed and operate in a specific orientation. Therefore, the above-mentioned orientation or position relationship terms cannot be understood or interpreted as limitations on the scheme of the present disclosure.

In addition, the terms “first” or “second” used in the present disclosure to refer to numbers or ordinals are only used for descriptive purposes and cannot be understood as explicitly or implicitly indicating relative importance or implicitly indicating the number of technical features indicated. Therefore, a feature defined as “first” or “second” may explicitly or implicitly include at least one such feature. In the description of the present disclosure, the meaning of “plurality” is at least two, such as two, three, or more, etc., unless otherwise clearly and specifically defined.

The above description is only an implementation method of the present disclosure, and does not limit the patent scope of the present disclosure. Any equivalent structure or equivalent process transformation made using the contents of the present disclosure and drawings, or directly or indirectly used in other related technical fields, are also included in the patent protection scope of the present disclosure.

What is claimed is:

1. An earphone, comprising a wearing component, a first loudspeaker component, a second loudspeaker component, a first antenna, a second antenna, and a control module, wherein
the wearing component connects the first loudspeaker component and the second loudspeaker component so that in a wearing state, the first loudspeaker component and the second loudspeaker component are arranged on two sides of a head of a user, respectively;
the first antenna is carried on the first loudspeaker component, and the second antenna is carried on the second loudspeaker component; and
the control module is configured to set one of the first antenna and the second antenna to a working state, and set the other of the first antenna and the second antenna to a standby state, and the control module is further configured to switch the one of the first antenna and the second antenna to the standby state and switch the other of the first antenna and the second antenna to the working state in response to determining that a current antenna communication performance parameter of the earphone is smaller than or equal to a preset threshold.

2. The earphone of claim 1, wherein the current antenna communication performance parameter of the earphone when the communication between the earphone and a paired device starts to lag is designated as the preset threshold.

3. The earphone of claim 1, wherein, the current antenna communication performance parameter is a received signal strength indicator (RSSI) or a received channel power indicator (RCPI).

4. The earphone of claim 1, wherein the earphone further comprises a radio frequency chip and a switching element, the control module is configured to control the switching element to connect the one of the first antenna and the second antenna to a radio frequency port of the radio frequency chip so that the one of the first antenna and the second antenna is in the working state, and the control module is further configured to control the switching element to disconnect the other of the first antenna and the second antenna from the radio frequency port of the radio frequency chip so that the other of the first antenna and the second antenna is in the standby state.

5. The earphone of claim 4, wherein the control module and the radio frequency chip are integrated on the same main chip.

6. The earphone of claim 4, wherein the control module and the radio frequency chip are two independent chips.

7. The earphone of claim 4, wherein the radio frequency chip and the switching element are carried on the first loudspeaker component, the second antenna is configured to be connected to the switching element via a radio frequency trace carried on the wearing component, and the control module is configured to set the first antenna to the working state in response to a power-on instruction of the earphone.

8. The earphone of claim 4, further comprising a circuit board component and a battery, wherein the control module, the radio frequency chip, and the switching element are arranged on the circuit board component, the first antenna and the circuit board component are arranged in a housing of the first loudspeaker component, the second antenna and the battery are arranged in a housing of the second loudspeaker component, and a clearance of the first antenna is greater than a clearance of the second antenna.

9. The earphone of claim 8, wherein the control module is configured to set the first antenna to the working state in response to a power-on instruction of the earphone.

10. The earphone of claim 9, wherein the second antenna is configured to be connected to the switching element via a radio frequency trace carried on the wearing component, the first antenna is provided with a first feed point and a grounding point, and the second antenna is only provided with a second feed point connected to the radio frequency trace.

11. The earphone of claim 10, wherein the first feed point is connected to the switching element, and the grounding point is connected to a common terminal on the circuit board component.

12. The earphone of claim 10, wherein the second feed point is connected to the switching element via the radio frequency trace.

13. The earphone of claim 9, wherein the first antenna is a Planar Inverted-F Antenna (PIFA), and the second antenna is a monopole antenna.

14. The earphone of claim 9, wherein the first antenna and the second antenna are antennas of the same type.

15. The earphone of claim 8, further comprising a boom microphone component, wherein the boom microphone component includes a boom arm, a microphone, and a pivot mechanism, the microphone and the pivot mechanism are arranged at two ends of the boom arm, respectively, the pivot mechanism is rotatably connected to the housing of the first loudspeaker component, and the first antenna is arranged around a periphery of the pivot mechanism in a semi-closed manner.

16. The earphone of claim 15, wherein a shape of the first antenna is adapted to match a contour of the housing, and is integrally arranged in a “C” shape.

17. The earphone of claim 1, wherein in at least one horizontal plane gain radiation pattern equidistant from the first antenna and the second antenna, within a first angle range, a radiation gain of the first antenna is better than a radiation gain of the second antenna, and within a second angle range, the radiation gain of the second antenna is better than the radiation gain of the first antenna, the first angle range is larger than the second angle range, and the control module is configured to set the first antenna to the working state in response to a power-on instruction of the earphone.

18. The earphone of claim 1, wherein the control module is configured to detect a signal strength received by the one of the first antenna and the second antenna in the working state, and generate the current antenna communication performance parameter in real-time;
or the control module is configured to receive the current antenna communication performance parameter or a switching instruction generated based on the current antenna communication performance parameter from a paired device, the paired device is connected to the earphone through the one of the first antenna and the second antenna in the working state, and is configured to generate the current antenna communication performance parameter in real-time based on the signal strength.

19. A method for controlling an earphone, wherein the earphone comprises a wearing component, a first loudspeaker component, a second loudspeaker component, a first antenna, and a second antenna; the wearing component connects the first loudspeaker component and the second loudspeaker component so that in a wearing state, the first loudspeaker component and the second loudspeaker component are arranged on two sides of a head of a user, respectively, the first antenna is carried on the first loudspeaker component, and the second antenna is carried on the second loudspeaker component; and the method comprises:
setting one of the first antenna and the second antenna to a working state, and setting the other of the first antenna and the second antenna to a standby state;
determining whether a current antenna communication performance parameter of the earphone is smaller than or equal to a preset threshold; and
switching the one of the first antenna and the second antenna to the standby state and switching the other of the first antenna and the second antenna to the working state in response to determining that the current antenna communication performance parameter of the earphone is smaller than or equal to the preset threshold.

20. The method of claim 19, wherein the determining whether a current antenna communication performance parameter of the earphone is smaller than or equal to a preset threshold includes:
detecting a signal strength received by the one of the first antenna and the second antenna in the working state, and generating the current antenna communication performance parameter in real-time, and determining whether the current antenna communication performance parameter is smaller than or equal to the preset threshold; or
receiving the current antenna communication performance parameter or a switching instruction generated based on the current antenna communication performance parameter from a paired device, wherein the paired device is connected to the earphone through the one of the first antenna and the second antenna in the working state, and generating the current antenna communication performance parameter in real-time based on the signal strength.
